(19) United States
(12) Patent Application Publication
(10) Pub. No.: US 2006/0065767 A1
(43) Pub. Date: Mar. 30, 2006

(54) Scrap device for removing debris on filter of food processors

(76) Inventor: Wei-Chin Lin, Banchiao City (TW)

Correspondence Address: TROXELL LAW OFFICE PLLC, SUITE 1404, 5205 LEESBURG PIKE, FALLS CHURCH, VA, 22041, US

(21) Appl. No.: 10/950,518

(22) Filed: Sep. 28, 2004

(51) Int. Cl. B02C 18/12

(52) U.S. Cl. 241/74; 241/282.1

(57) ABSTRACT

A scrap device for a food processor is connected to the cap of the processor and the cap includes a feeding tube which is located above the grinding plate of the processing unit. The grinding plate includes blades for grinding fruit or food and is driven by a motor. A filter extends from a periphery of the grinding plate and the scrap plate keeps a proper a gap between an inside of the filter and the scrap device. The scrap plate is stationary and the filter is rotated together with the grinding plate so that the scrap plate remove the debris attached on the filter which operating the food processor.

### FIELD OF THE INVENTION

The present invention relates to a scrap device which is located at an inside of the filter which spins relative to the scrap device so that debris on the filter can be removed.

### BACKGROUND OF THE INVENTION

A conventional food processor “a” is disclosed in FIGS. 8 and 9, and generally includes a top cap “b” having a feeding tube “b1” which includes a passage “b2” for feeding food or fruits therein. A grinding plate “c” with teeth “c1” is located beneath the feeding tube “b1” and driven by a motor “h”. A filtering unit “e” is connected to the grinding plate “c” and includes a filter “e1”. Food or fruit is fed into the passage “b2” and ground by the grinding plate “c”, and juice is collected from the outlet “f” and debris is collected in the container “d”. However, it is experienced that the tiny holes in the filter “e1” are blocked by debris “g” within a short period of time especially the fruit involves fibers or gelatinous ingredients. The users then have to disengage the food processor and clean up the debris “g” attached on the filter. This wastes a lot of time and messes up the table.

The present invention intends to provide a scrap device which scrapes the inside of the filter when the filter spins during operation of the food processor so that the filter is maintained functionable during a long period of operation time.

### SUMMARY OF THE INVENTION

The present invention relates to a food processor which comprises a base with a motor and a body is mounted to the base. A processing unit is received in the space in the body and includes a grinding plate and a filter extending from a periphery of the grinding plate which has blades extending from a top thereof. A cap is mounted on the body and has a feeding tube extending from an underside thereof so as to feed food or fruit from a passage in the feeding tube by a plunger. A scrap device is connected to the cap and includes a scrap plate which is located such that a gap is defined between an inside of the filter and the scrap plate.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the food processor of the present invention;

FIG. 2 shows a bottom of the cap of the food processor of the present invention;

FIG. 3 is a cross sectional view of the food processor of the present invention;

FIG. 4 shows the operation of the food processor of the present invention;

FIG. 5 is a top view to show the scrap plate and the inside of the filter;

FIG. 6 shows another embodiment of the scrap device;

FIG. 7 shows yet another embodiment of the scrap device;

FIG. 8 is a cross sectional view of a conventional food processor, and

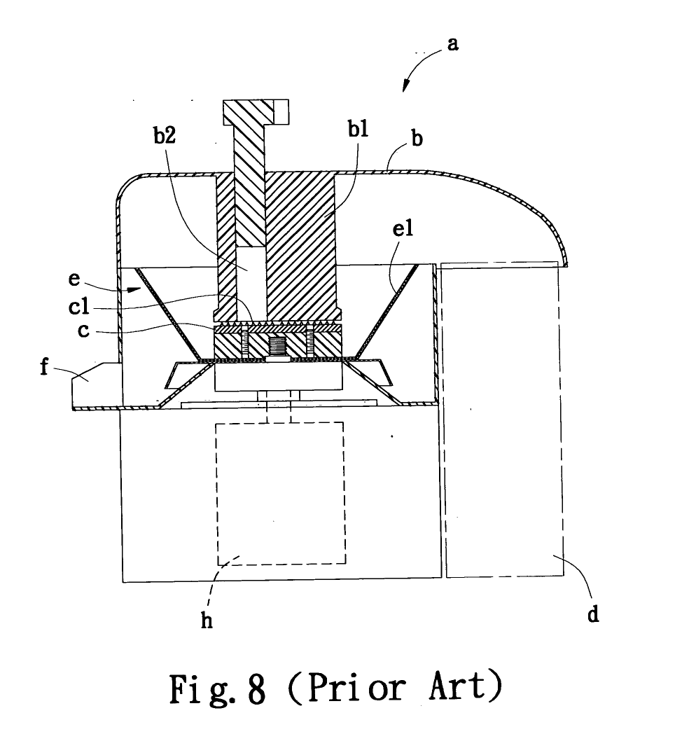

FIG. 9 shows the filter of the conventional food processor is attached with debris of the fruit.

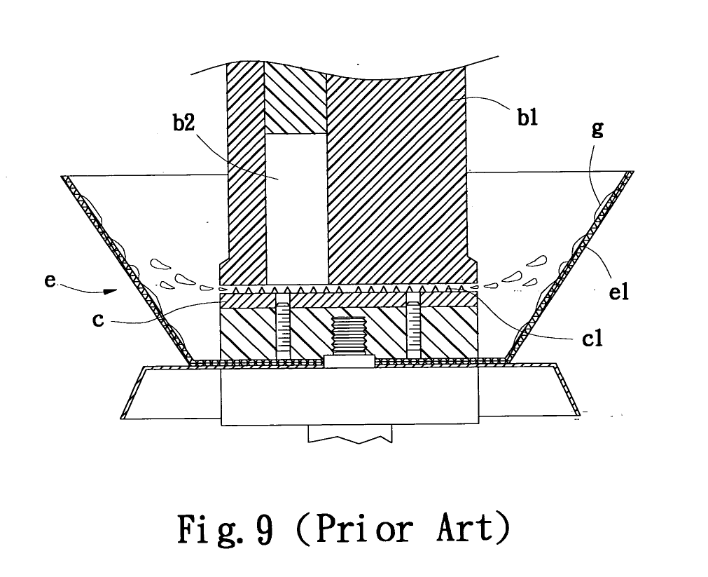

### DETAILED DESCRIPTION OF THE PREFERRED EMBODIMENT

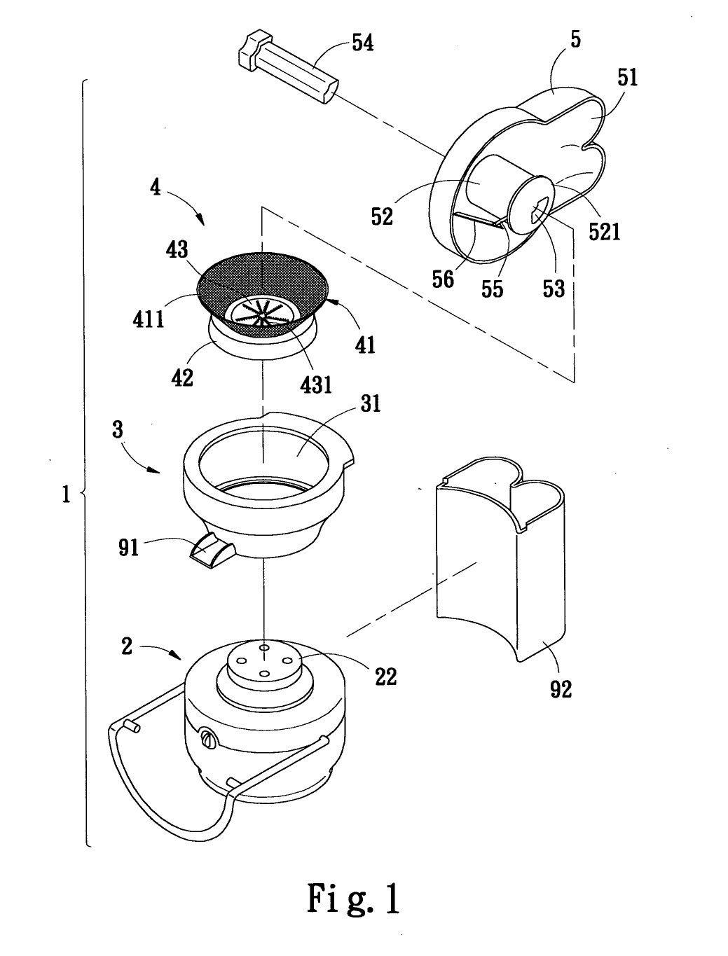

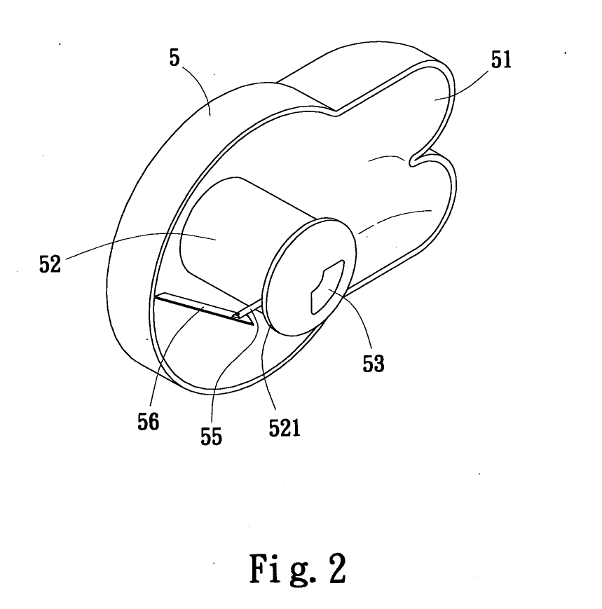

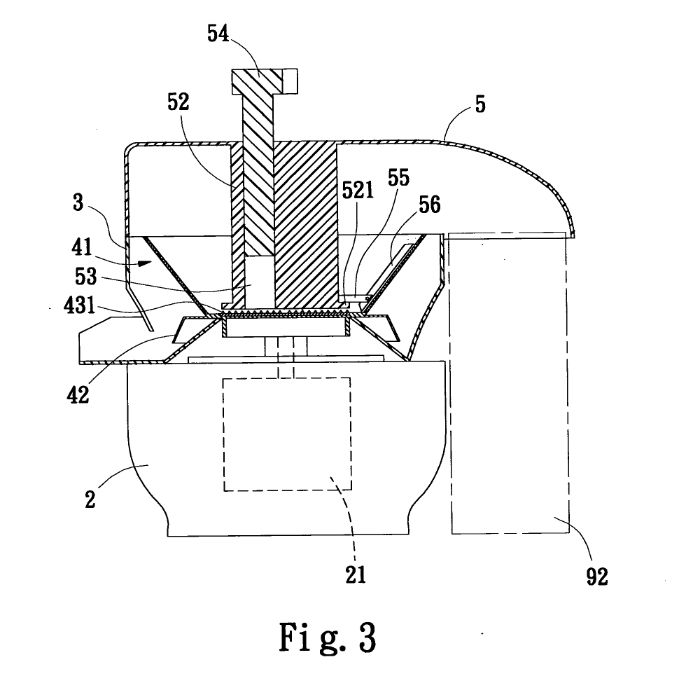

Referring to FIGS. 1 to 3, the food processor 1 of the present invention comprises a base 2 with a motor 21 connected thereto and a connection port 22 of the motor 21 is located on a top of the base 2. A body 3 has two open ends and is mounted on the base 2. A space 31 is defined in the body 3 and the connection port 22 of the motor 21 is located in the space 31. The body 3 further has an outlet 91 defined through the body 3 so as to collect juice therefrom.

A processing unit 4 is received in the space 31 in the body 3 and includes a grinding plate 43 which has blades 411 extending from a top thereof. A filter 41 extends from a periphery of the grinding plate 43 and includes an inclined inside. A plurality of tiny holes 411 are defined through the filter 41. A skirt portion 42 connected to the grinding plate 43 so as to prevent juice from entering the area where the motor 21 is located.

A cap 5 is mounted on the body 3 and has a feeding tube 52 extending from an underside thereof. A passage 53 is defined through the feeding tube 52 and a plunger 54 is movably inserted in the passage 53 to feed food or fruit toward the processing unit 4. A flange 521 extends radially outward from a distal end of the feeding tube 52.

A scrap device is connected to the cap 5 and includes a scrap plate 56 which maintains a gap 6 between the inside of the filter 41 and the scrap plate 56. The scrap plate 56 is connected to a first end of a rod 55 and a second end of the rod 55 is connected to the flange 521 of the feeding tube 52. The first end of the rod 55 is connected to one of two ends of the scrap plate 56.

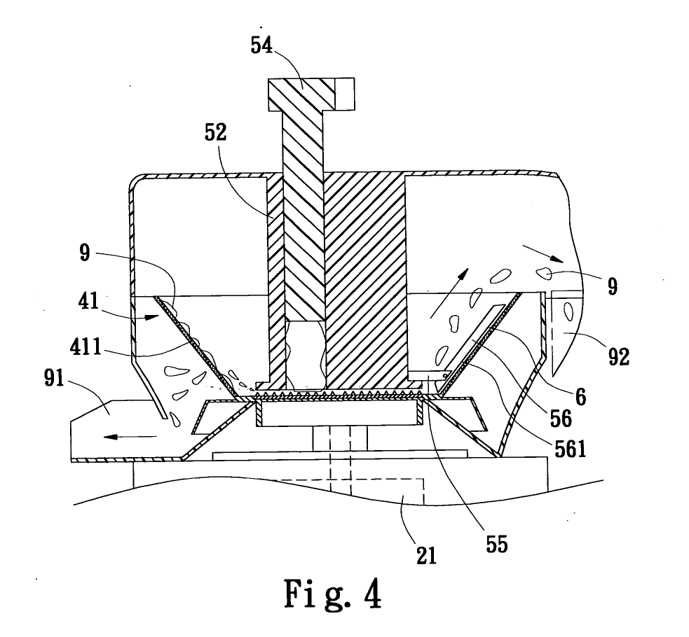

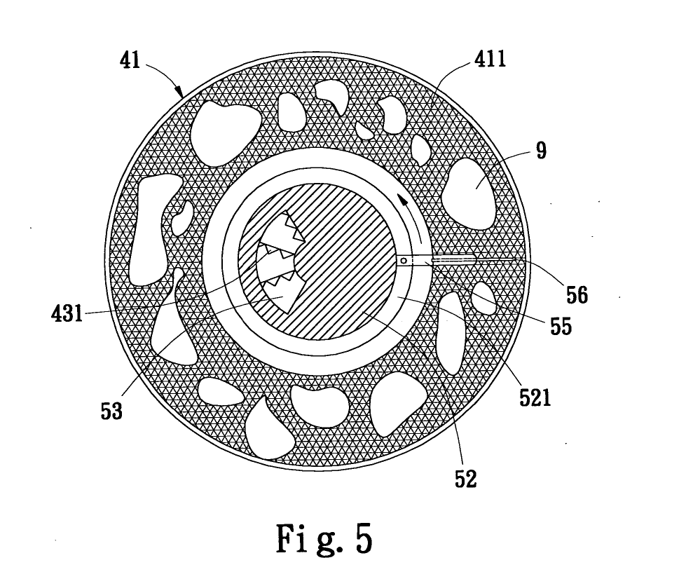

Referring to FIGS. 4 and 5, when the motor 21 drives the processing unit 4 to spin, the scrap plate 56 is stationary so that the debris 9 can be removed from the inside of the filter 41 by an edge 561 of the scrap plate 56 and is collected in the container 92 which is connected to the communication recesses 51 defined in the underside of the cap 5.

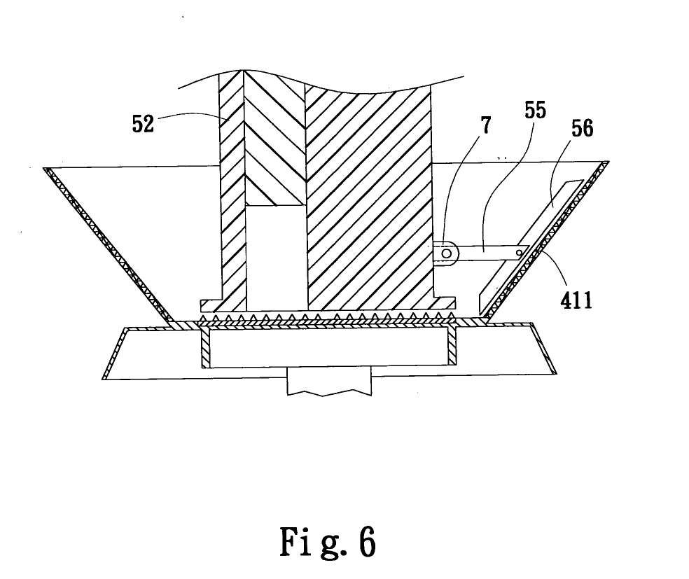

FIG. 6 shows another embodiment of the scrap device wherein a connection member 7 extends from an outer periphery of the feeding tube 52 and the second end of the rod 55 is pivotably connected to the connection member 7. The first end of the rod 55 is connected to a mediate portion of the scrap plate 56.

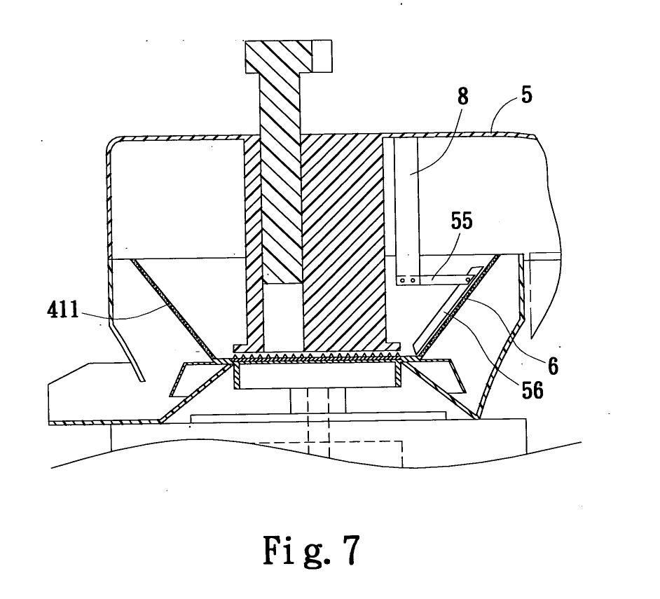

FIG. 7 shows yet another embodiment of the scrap device wherein a bar 8 extends from the underside of the cap 5 and the scrap plate 56 is connected to a first end of the rod 55 and a second end of the rod 55 is connected to the extension bar 8. The first end of the rod 55 is connected to one of two ends of the scrap plate 56.

While we have shown and described the embodiment in accordance with the present invention, it should be clear to those skilled in the art that further embodiments may be made without departing from the scope of the present invention.

What is claimed is:

1. A food processor comprising:
a base with a motor connected thereto;
a body having two open ends and mounted on the base, a space defined in the body and a connection port of the motor located in the space, an outlet defined through the body;
a processing unit received in the space in the body and including a grinding plate and a filter extending from a periphery of the grinding plate which has blades extending from a top thereof;
a cap mounted on the body and having a feeding tube extending from an underside thereof, a passage defined through the feeding tube and a plunger movably inserted in the passage, and
a scrap device connected to the cap and including a scrap plate and a gap defined between an inside of the filter and the scrap plate.

2. The processor as claimed in claim 1, wherein the scrap plate is connected to a first end of a rod and a second end of the rod is connected to the feeding tube.

3. The processor as claimed in claim 2, wherein a flange extends radially outward from a distal end of the feeding tube and the second end of the rod is connected to the flange.

4. The processor as claimed in claim 2, wherein the first end of the rod is connected to one of two ends of the scrap plate.

5. The processor as claimed in claim 2, wherein a connection member extends from an outer periphery of the feeding tube and the second end of the rod is pivotably connected to the connection member.

6. The processor as claimed in claim 5, wherein the first end of the rod is connected to a mediate portion of the scrap plate.

7. The processor as claimed in claim 1 further comprising a bar extending from the underside of the cap and the scrap plate is connected to a first end of the rod, a second end of the rod connected to the extension bar.

8. The processor as claimed in claim 7, wherein the first end of the rod is connected to one of two ends of the scrap plate.

9. The processor as claimed in claim 1 further comprising a container connected to the underside of the cap.
